(19) United States
(12) Patent Application Publication
(10) Pub. No.: US 2009/0246043 A1
(43) Pub. Date: Oct. 1, 2009

(54) FAN MOTOR

(75) Inventor: Keishi OTSUBO, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/415,536

(22) Filed: Mar. 31, 2009

(30) Foreign Application Priority Data
Mar. 31, 2008 (JP) 2008-091711

(51) Int. Cl. F04D 25/08; H02K 7/14

(52) U.S. Cl. 417/354; 310/75 R

(57) ABSTRACT

A fan motor may include a rotor part having a drive magnet and a stator part having a drive coil and rotatably holding the rotor part. The rotor part may include a rotor yoke to which the drive magnet is fixed on an inner peripheral side of the rotor yoke, an impeller which is provided with a plurality of blades and disposed on an outer peripheral side of the rotor yoke, and a plurality of ribs which are protruded from at least one of an inner peripheral face of the impeller and an outer peripheral face of the rotor yoke in a radial direction. The rotor yoke may be press-fitted to the impeller so that end parts in the radial direction of the ribs are abutted with at least one of the inner peripheral face of the impeller and the outer peripheral face of the rotor yoke, and gap spaces are formed between adjacent ribs of the plurality of the ribs and between the inner peripheral face of the impeller and the outer peripheral face of the rotor yoke.

### CROSS REFERENCE TO RELATED APPLICATION

The present invention claims priority under 35 U.S.C. §119 to Japanese Application No. 2008-91711 filed Mar. 31, 2008, the entire contents of which are incorporated herein by reference.

### FIELD OF THE INVENTION

An embodiment of the present invention may relate to a fan motor.

### BACKGROUND OF THE INVENTION

A fan motor for cooling has been conventionally mounted on an electronic apparatus for radiating heat that is generated inside the apparatus. The fan motor includes a rotor part having a rotor magnet and a stator part having a motor coil (see, for example, Japanese Patent Laid-Open No. 2007-100600). In this Patent Reference, a rotor part having a rotor yoke which is integrally molded with an impeller that is made of resin is disclosed. Further, in the Patent Reference, a rotor part having a rotor yoke which is press-fitted and fixed to the inside of the impeller made of resin is also disclosed.

With the higher performance of electronic devices in recent years, a higher cooling ability is required in a fan motor respectively. In other words, performance capability for quickly radiating heat, including heat at higher temperatures, is required in a modern fan motor. However, the present inventor has found that, like a fan motor described in the above-mentioned Patent Reference, in a case that the rotor yoke is integrally molded with the impeller or, in a case that the rotor yoke is simply press-fitted to the inside of the impeller, when the fan motor is rotated at a high speed or used under a high temperature circumstances, the impeller is easily cracked due to a centrifugal force occurred at a high-speed rotation or a difference of coefficients of thermal expansion of the rotor yoke and the impeller.

### SUMMARY OF THE INVENTION

In view of the problems described above, at least an embodiment of the present invention may advantageously provide a fan motor in which cracking of the impeller is restrained.

According to at least an embodiment of the present invention, there may be provided a fan motor including a rotor part, which includes a drive magnet, and a stator part which includes a drive coil and rotatably holds the rotor part. The rotor part includes a rotor yoke to which the drive magnet is fixed on an inner peripheral side of the rotor yoke, an impeller which is provided with a plurality of blades and which is disposed on an outer peripheral side of the rotor yoke, and a plurality of ribs which are protruded from at least one of an inner peripheral face of the impeller and an outer peripheral face of the rotor yoke in a radial direction with a predetermined interval. The rotor yoke is press-fitted to the impeller so that end parts in the radial direction of the ribs are abutted with at least one of the inner peripheral face of the impeller and the outer peripheral face of the rotor yoke, and gap spaces are formed between adjacent ribs of the plurality of the ribs and between the inner peripheral face of the impeller and the outer peripheral face of the rotor yoke.

In the fan motor in accordance with an embodiment of the present invention, the rotor yoke is press-fitted to the impeller so that end parts in the radial direction of the ribs are abutted with at least one of the inner peripheral face of the impeller and the outer peripheral face of the rotor yoke, and gap spaces are formed between adjacent ribs of the plurality of the ribs and between the inner peripheral face of the impeller and the outer peripheral face of the rotor yoke. Therefore, even when stress occurs in the impeller due to a centrifugal force, thermal expansion or the like occurred at the time of high-speed rotation, the gap spaces between the inner peripheral face of the impeller and the outer peripheral face of the rotor yoke serve as a relief part for the stress. Accordingly, according to this embodiment, even when the fan motor is rotated at a high speed or, even when the fan motor is used under a high temperature situation, an excessive stress is not applied to the impeller and thus cracking of the impeller is restrained.

In accordance with an embodiment of the present invention, the ribs are formed on at least one of the inner peripheral face of the impeller and the outer peripheral face of the rotor yoke with a substantially equal angular pitch. According to this structure, the gap spaces between the inner peripheral face of the impeller and the outer peripheral face of the rotor yoke are disposed with a substantially equal interval in the circumferential direction. Therefore, deformation of the impeller can be relieved in a roughly equalized manner and thus stress at the time of deformation is hardly concentrated on a specified portion. As a result, cracking of the impeller is restrained effectively.

In accordance with an embodiment of the present invention, the rib is formed on the inner peripheral face of the impeller so as to correspond to a forming position of the blade which is formed on the outer peripheral face of the impeller. According to this structure, the blades are fixed to the rotor yoke in the state that the blades are directly abutted with the outer peripheral face of the rotor yoke through the ribs. Therefore, in comparison with a case that the blades are formed on the outer peripheral face of impeller at positions of the gap spaces formed between the inner peripheral face of the impeller and the outer peripheral face of the rotor yoke, the shape of the blades of the impeller is difficult to be deformed and thus a stable shape can be maintained.

In accordance with an embodiment of the present invention, the impeller is formed of resin in a bottomed cylindrical shape, the rotor yoke is formed in a bottomed cylindrical shape having a bottom part and a cylindrical part to which the drive magnet is fixed, the rib is formed on the inner peripheral face of the impeller, and an inner side end in the radial direction of the rib and the outer peripheral face of the cylindrical part of the rotor yoke are abutted with each other, and the bottom part of the rotor yoke is abutted with a bottom part of the impeller. According to this structure, the rotor yoke is fixed to the impeller in the state that the outer peripheral face and the bottom part of the rotor yoke are abutted with the inner peripheral face and the bottom part of the impeller and thus a stable fixed state is maintained.

In accordance with an embodiment of the present invention, a rotation shaft structuring the rotor part is fixed to the impeller by insert molding. According to this structure, concentricity of the rotation shaft, which is fixed to the impeller, with the rotor yoke is easily enhanced.

In accordance with an embodiment of the present invention, the impeller is formed of resin in a bottomed cylindrical shape, the rotor yoke is formed in a bottomed cylindrical shape having a bottom part which is abutted with a bottom part of the impeller, the bottom part of the impeller is formed with a projecting part which is protruded in an axial direction, the bottom part of the rotor yoke is formed with an engaging hole with which the projecting part is engaged, a tip end of the projecting part which is disposed on an edge of the engaging hole is protruded in the axial direction with respect to the engaging hole to be formed as a thermal welding part for fixing the impeller to the rotor yoke by thermal welding, and the thermal welding part is melted by heat to be thermally welded to the edge of the engaging hole. According to this structure, the tip end of the projecting part protruding in the axial direction from the bottom part of the impeller serves as the thermal welding part and thus the impeller and the rotor yoke are firmly fixed to each other without affecting such as deforming another portion of the impeller.

Further, in this case, it is preferable that the bottom part of the impeller is formed with a plurality of the projecting parts in a ring-shaped manner, and the engaging hole is formed in a circular shape at a center of the bottom part of the rotor yoke. According to this structure, the impeller and the rotor yoke are further firmly fixed to each other.

In accordance with an embodiment of the present invention, the bottom part of the impeller is formed with an abutting part for abutting with the stator part to restrict movement of the rotor part in the axial direction, and the abutting part is protruded in same direction as the projecting part, and a protruding amount of the abutting part in the axial direction is larger than a protruding amount of the projecting part. According to this structure, the stator part does not abut with the thermal welding parts and thus damage of the thermal welding part due to abutting with the stator part is prevented.

In accordance with an embodiment of the present invention, the impeller is formed of resin in a bottomed cylindrical shape, the rotor yoke is formed in a bottomed cylindrical shape having a bottom part which is abutted with a bottom part of the impeller, the rib is formed on the inner peripheral face of the impeller so as to reach at least to a boundary portion between the inner peripheral face of the impeller and the bottom part of the impeller, and the bottom part of the impeller is formed with radial ribs extending from end parts of the ribs toward a center of the bottom part of the impeller so as to protrude in the axial direction, and the bottom part of the rotor yoke is abutted with the radial ribs. According to this structure, even when the bottom part of the rotor yoke is abutted with the bottom part of the impeller for positioning the rotor yoke in the axial direction, a thickness of the bottom part of the impeller can be set arbitrarily. Therefore, wall thicknesses of respective portions of the impeller formed of resin can be roughly equalized and thus shrinkage at the time of resin molding can be prevented.

In accordance with an embodiment of the present invention, an inner side end of the radial rib is formed with a projecting part protruding in the axial direction from the radial rib, the bottom part of the rotor yoke is formed with an engaging hole with which the projecting part is engaged, a tip end of the projecting part which is disposed on an edge of the engaging hole is protruded in the axial direction with respect to the engaging hole to be formed as a thermal welding part for fixing the impeller to the rotor yoke by thermal welding, and the thermal welding part is melted by heat to be thermally welded to the edge of the engaging hole.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a cross-sectional view showing a schematic structure of a fan motor in accordance with an embodiment of the present invention.

FIG. 2 is a perspective view showing a rotor part in FIG. 1 which is viewed from an upper side.

FIG. 3 is a perspective view showing the rotor part in FIG. 1 which is viewed from a lower side.

FIG. 4 is a bottom view showing the rotor part in FIG. 1.

FIG. 5 is an exploded perspective view showing the rotor part in FIG. 1.

FIG. 6 is a cross-sectional view showing a schematic structure of a fan motor in accordance with another embodiment of the present invention.

### DETAILED DESCRIPTION OF THE PREFERRED EMBODIMENTS

An embodiment of the present invention will be described below with reference to the accompanying drawings.

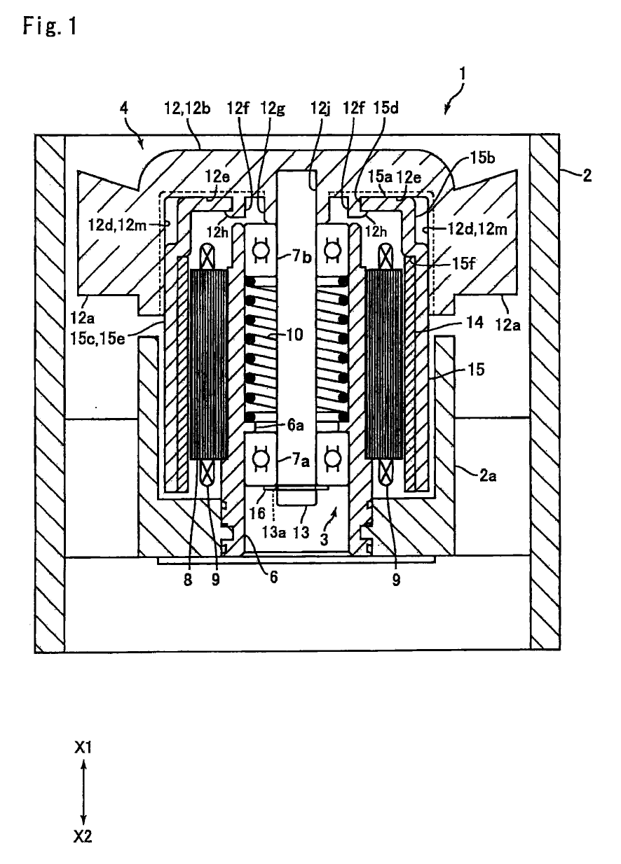

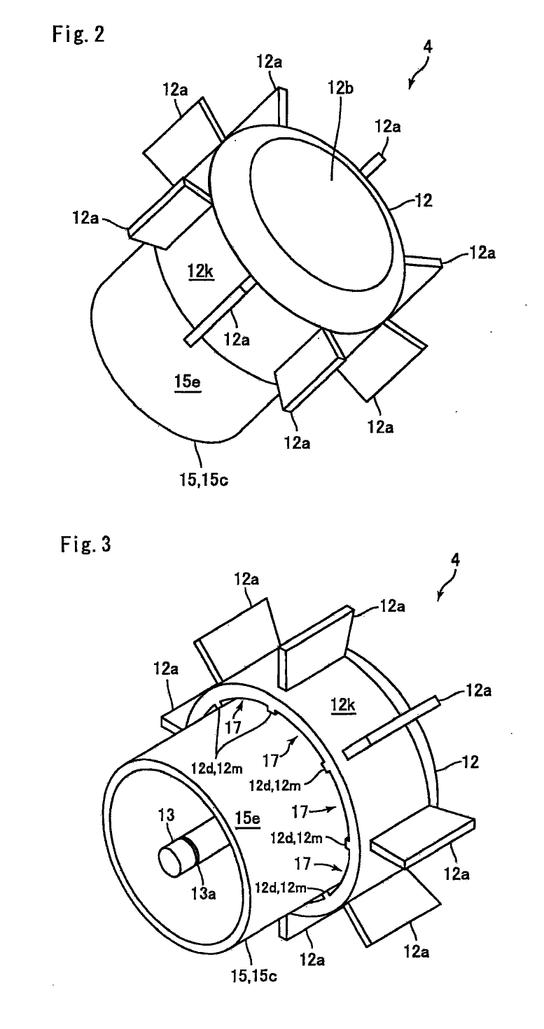

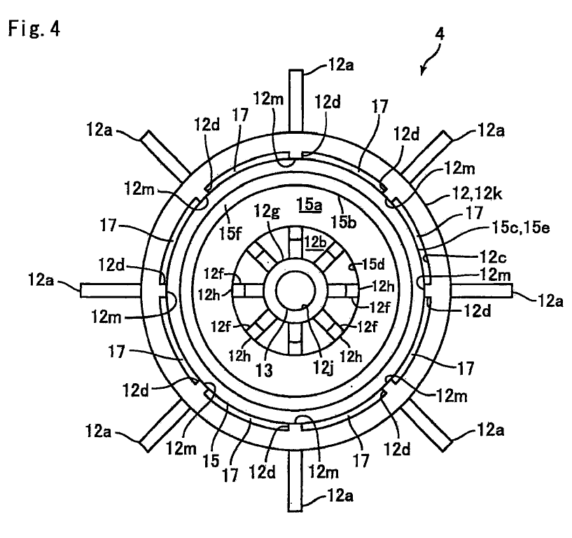

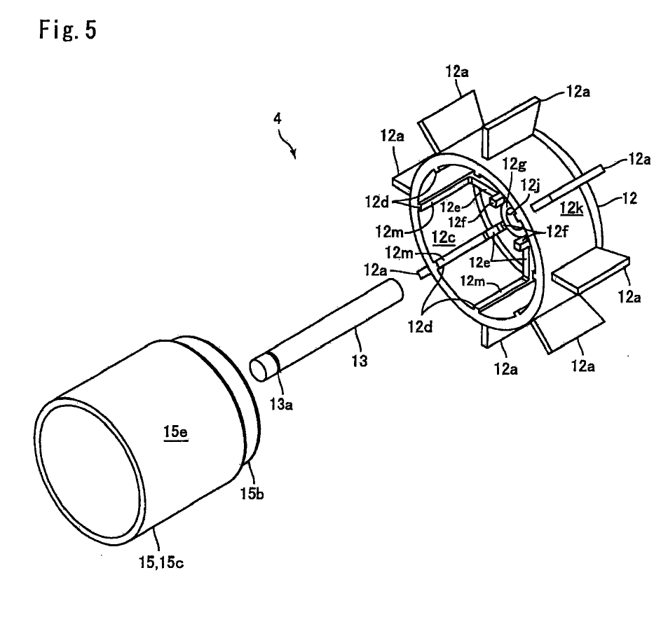

FIG. 1 is a cross-sectional view showing a schematic structure of a fan motor 1 in accordance with an embodiment of the present invention. FIG. 2 is a perspective view showing a rotor part 4 in FIG. 1 which is viewed from an upper side. FIG. 3 is a perspective view showing the rotor part 4 in FIG. 1 which is viewed from a lower side. FIG. 4 is a bottom view showing the rotor part 4 in FIG. 1. FIG. 5 is an exploded perspective view showing the rotor part in FIG. 1. In FIGS. 3 through 5, a drive magnet 14 is not shown. Further, in this specification, the “Xr” direction in FIG. 1 is referred to as an “upper side” and the “X2” direction is referred to as a “lower side”.

The fan motor 1 in this embodiment is a motor for cooling, for example, for radiating heat generated in an inside of an electronic apparatus. As shown in FIG. 1, the fan motor 1 includes a case body 2, and a stator part 3 and a rotor part 4 which are disposed in an inside of the case body 2. The stator part 3 is fixed to the case body 2. The rotor part 4 is rotatably held by the stator part 3.

The stator part 3 includes a bearing holder 6 which is formed in a roughly cylindrical shape, two bearings 7a and 7b which are disposed on an inner peripheral side of the bearing holder 6, a stator core 8 which is fixed on an outer peripheral face of the bearing holder 6, and a drive coil 9 which is wound around the stator core 8.

A lower end of the bearing holder 6 is fixed to a stator fixing part 2a which is formed on a lower side of the case body 2. Further, an inner peripheral face of the bearing holder 6 is formed with a protruded part 6a protruding inside in a radial direction. One of two bearings 7a is disposed in the inside on the lower side of the bearing holder 6 in a state that its upper face is abutted with the protruded part 6a. Further, the other bearing 7b is disposed in the inside on an upper end of the bearing holder 6 in a state that its lower face is abutted with an upper end of a compression coil spring 10 whose lower end is abutted with the protruded part 6a. In other words, the protruded part 6a serves as a positioning part for determining the positions of the bearings 7a and 7b which are disposed at lower and upper positions.

The stator core 8 is, for example, a laminated core which is formed by means of that thin plates made of magnetic material are laminated on each other. The stator core 8 is formed with a plurality of salient pole parts, around which the drive coil 9 is wound, so as to protrude outside in the radial direction.

The rotor part 4 includes an impeller 12 having a plurality of blades 12a, a rotation shaft 13 rotating together with the impeller 12, a drive magnet 14 which is formed in a cylindrical shape, and a rotor yoke 15 to which the drive magnet 14 is fixed.

Two portions of the rotation shaft 13, its upper side and lower end, are rotatably supported by two bearings 7a and 7b. The impeller 12 is fixed to the upper end of the rotation shaft 13. In this embodiment, the impeller 12 is formed of resin and the impeller 12 is integrally formed with the rotation shaft 13 by insert molding. Further, a fixing groove 13a to which a retaining ring 16 for preventing coming-out of the rotation shaft 13 from the bearing 7a is fixed is formed at the lower end of the rotation shaft 13. The retaining ring 16 that is fixed to the fixing groove 13a is abutted with a lower face of the bearing 7a which is disposed on the lower side.

The rotor yoke 15 is formed of magnetic material. The rotor yoke 15 in this embodiment is formed of an electro-galvanized steel plate (SECC). Further, the rotor yoke 15 in this embodiment is formed by drawing work of a flat plate of SECC. As shown in FIG. 1, the rotor yoke 15 is formed in a substantially bottomed cylindrical shape having a bottom part 15a. Specifically, the rotor yoke 15 is structured of the bottom part 15a, a small diameter cylindrical part 15b whose upper end is connected with the bottom part 15a, and a large diameter cylindrical part 15c whose upper end is connected with the small diameter cylindrical part 15b and whose inner diameter and outer diameter are larger than the small diameter cylindrical part 15b. A center of the bottom part 15a is formed with a circular engaging hole 15d with which projecting parts 12f structuring the impeller 12 are engaged.

The drive magnet 14 is fixed on an inner peripheral face of the large diameter cylindrical part 15c. Specifically, the drive magnet 14 is fixed on an inner peripheral face of the large diameter cylindrical part 15c in a state that its upper end is abutted with a stepped part 15f formed at a boundary portion between the small diameter cylindrical part 15b and the large diameter cylindrical part 15c. In this embodiment, as shown in FIG. 1, the inner peripheral face of the drive magnet 14 is disposed on an outer side of the inner peripheral face of the small diameter cylindrical part 15b in the radial direction and thus the drive magnet 14 does not protrude on the inner peripheral side with respect to the small diameter cylindrical part 15b. In this embodiment, the drive magnet 14 fixed to the rotor yoke 15 is disposed on an outer side of the stator core 8 in the radial direction so as to face each other. In other words, the fan motor 1 in this embodiment is an outer rotor type motor.

The impeller 12 is formed of resin. The impeller 12 in this embodiment is formed of polybutylene terephthalate (PBT). Further, the impeller 12 is formed in a roughly bottomed cylindrical shape having a bottom part 12b abutting with an upper face of the bottom part 15a of the rotor yoke 15. An outer peripheral face of the impeller 12 is formed with a plurality of blades 12a which are formed in a thin plate shape and protruded on an outer side in the radial direction. In this embodiment, eight blades 12a are formed on the outer peripheral face of the impeller 12 with a substantially equal angular pitch.

As shown in FIG. 5 and the like, a plurality of ribs 12d which are protruded on inner sides in the radial direction and formed in a substantially rectangular solid shape is formed on an inner peripheral face 12c of a cylindrical part 12k of the impeller 12. Specifically, a plurality of the ribs 12d is formed on the inner peripheral face 12c of the impeller 12 with a predetermined interval in a circumferential direction and over the entire region of the cylindrical part 12k of the impeller 12 in the axial direction. In this embodiment, eight ribs 12d are formed with a substantially equal angular pitch so as to correspond to forming positions of the blades 12a, i.e., on the inner sides of the blades 12a in the radial direction. A thickness in the circumferential direction of the rib 12d is roughly equal to a thickness of the blade 12a.

A center of a lower face of the bottom part 12b of the impeller 12 is formed with a fixing hole 12j to which the rotation shaft 13 is fixed. As shown in FIG. 5 and the like, radial ribs 12e which are formed in a substantially rectangular solid shape and connected with the ribs 12d are formed on the lower face of the bottom part 12b of the impeller 12 so as to protrude downward. Specifically, the radial ribs 12e are radially formed from an upper end part of the rib 12d formed on the inner peripheral face 12c of the impeller 12 toward the center in the radial direction of the bottom part 12b. Inner side ends of the radial ribs 12e in the radial direction are formed with a substantially rectangular solid-shaped projecting part 12f which is protruded lower than the radial rib 12e. A plurality of the projecting parts 12f is disposed in a ring-shaped manner. As described above, in this embodiment, eight radial ribs 12e and projecting parts 12f are formed so as to correspond to the ribs 12d.

An abutting part 12g abutting with an upper face of the bearing 7b which is disposed on the upper side is formed on an inner side of the projecting part 12f in the radial direction so as to protrude downward from the lower face of the bottom part 12b. Specifically, the abutting part 12g in a substantially cylindrical shape is formed at an edge of the fixing hole 12j. In this embodiment, as shown in FIG. 1, a protruding amount in the axial direction of the abutting part 12g is set to be larger than a protruding amount in the axial direction of the projecting part 12f. The abutting part 12g is abutted with the bearing 7b to restrict movement of the rotor part 4 in the axial direction. In FIG. 5, the protruding amount of the abutting part 12g in the axial direction is shown to be smaller than the protruding amount of the protruded part 12f to show the protruded part 12f for convenience.

The impeller 12 is fixed to the outer peripheral side of the rotor yoke 15. Specifically, as shown in FIG. 4, the rotor yoke 15 is press-fitted into the impeller 12 so that the inner side ends 12m in the radial direction of the ribs 12d and the outer peripheral face 15e of the large diameter cylindrical part 15c of the rotor yoke 15 are abutted with each other and, in this manner, the impeller 12 is fixed to the outer peripheral side of the rotor yoke 15. In other words, the impeller 12 is fixed to the outer peripheral side of the rotor yoke 15 with the inner ends 12m in the radial direction of the ribs 12d and the outer peripheral face 15e of the rotor yoke 15 as references in the radial direction. In the state that the impeller 12 is fixed to the outer peripheral side of the rotor yoke 15, as shown in FIG. 4, gap spaces 17 are formed with a substantially equal angular pitch between the inner peripheral face 12c of the impeller 12 and the outer peripheral face 15e of the rotor yoke 15 which is located between a plurality of the ribs 12d which are adjacent to each other.

Further, in the state that the impeller 12 is fixed to the rotor yoke 15, the radial ribs 12e and the upper face of the bottom part 15a of the rotor yoke 15 are abutted with each other. In addition, in this state, the projecting parts 12f and the abutting part 12g are disposed within the engaging hole 15d of the rotor yoke 15. Further, tip ends of the projecting parts 12f and the abutting part 12g are protruded lower than the engaging hole 15d.

The projecting part 12f is disposed within the engaging hole 15d in the state that it is abutted with the edge part of the engaging hole 15d or with a slight gap space between the edge part of the engaging hole 15d and the projecting part 12f. Further, in this embodiment, the impeller 12 and the rotor yoke 15 are thermally welded to each other by utilizing the tip end of the projecting part 12f and the edge part of the engaging hole 15d. In other words, as shown in FIG. 1, the tip end of projecting part 12f disposed on the edge part of the engaging hole 15d is used as a thermal welding part 12h for fixing the impeller 12 to the rotor yoke 15 by thermal welding. The thermal welding part 12h is formed so that the tip end of the projecting part 12f is heated and melted to be thermally welded to the edge part of the engaging hole 15d.

The bearing 7b abutting with the abutting part 12g is urged upward by an urging force of the compression coil spring 10. In other words, the impeller 12 to which the rotation shaft 13 is fixed is urged upward by the urging force of the compression coil spring 10. Further, the retaining ring 16 abutting with the lower face of the bearing 7a which is disposed on the lower side is fixed to the lower end of the rotation shaft 13 and the upper face of the bearing 7a disposed on the lower side is abutted with the protruded part 6a of the bearing holder 6. Therefore, coming-out of the rotation shaft 13 from the bearings 7a and 7b is prevented.

In the fan motor 1 structured as described above, the rotor yoke 15 is press-fitted to the impeller 12 which is integrally molded with the rotation shaft 13 and the impeller 12 is thermally welded to the rotor yoke 15. After that, the drive magnet 14 is fixed to the inner peripheral face of the rotor yoke 15 and then rotation balance of the rotor part 4 is adjusted. In this embodiment, the outer peripheral face of the rotor yoke 15 is shaved to adjust the rotation balance of the rotor part 4. Specifically, two portions, i.e., the outer peripheral face of the rotor yoke 15 near the lower end of the impeller 12 and the outer peripheral face near the lower end of the rotor yoke 15 are shaved to adjust rotation balance of the rotor part 4.

As described above, in this embodiment, the rotor yoke 15 is press-fitted into the impeller 12 so that the inner side ends 12m in the radial direction of the ribs 12d and the outer peripheral face 15e of the large diameter cylindrical part 15c of the rotor yoke 15 are abutted with each other, and the gap spaces 17 are formed between the inner peripheral face 12c of the impeller 12 and the outer peripheral face 15e of the rotor yoke 15. Therefore, even when stress occurs in the impeller 12 due to a centrifugal force, thermal expansion or the like occurred at the time of high-speed rotation, the gap spaces 17 serve as a relief part for the stress. In other words, when stress occurs in the impeller 12 due to a centrifugal force, thermal expansion or the like, the stress is relieved by means of that the impeller 12 is deformed through the gap spaces 17. Therefore, in this embodiment, even when the fan motor 1 is rotated at a high speed or, even when the fan motor 1 is used under a high temperature situation, an excessive stress is not applied to the impeller 12 and thus cracking of the impeller 12 can be restrained.

Especially, in this embodiment, the ribs 12d are formed on the inner peripheral face 12c of the impeller 12 with a substantially equal angular pitch. In other words, the gap spaces 17 are disposed with an equal interval in the circumferential direction. Therefore, deformation of the impeller 12 can be relieved in a roughly equalized manner and thus stress at the time of deformation is hardly concentrated on a specified portion. As a result, cracking of the impeller 12 can be further effectively restrained.

Further, in this embodiment, the rotor yoke 15 is formed in a step-shaped cylindrical shape having the small diameter cylindrical part 15b and the large diameter cylindrical part 15c, and a gap space in the radial direction is formed between the outer peripheral face of the small diameter cylindrical part 15b and the inner side ends 12m in the radial direction of the ribs 12d in the state that the impeller 12 is fixed to the rotor yoke 15. Therefore, stress occurred in the impeller 12 due to a centrifugal force, thermal expansion or the like at the time of high-speed rotation can be relieved by utilizing the gap space in the radial direction.

In this embodiment, the impeller 12 is integrally molded with the rotation shaft 13 by insert molding and the rotation shaft 13 is directly fixed to the impeller 12. Therefore, the concentricity of the rotor yoke 15 with the rotation shaft 13 is easily enhanced.

In this embodiment, the tip end of the projecting part 12f which is disposed on the edge of the engaging hole 15d of the rotor yoke 15 is the thermal welding part 12h for fixing the impeller 12 to the rotor yoke 15 by thermal welding. In other words, the tip end of the projecting part 12f protruding in the axial direction from the bottom part 12b of the impeller 12 is the thermal welding part 12h. Therefore, the impeller 12 and the rotor yoke 15 are fixed to each other firmly without affecting such as deforming another portion of the impeller 12. Especially, in this embodiment, a plurality of the projecting parts 12f is disposed on the bottom part 12b of the impeller 12 in a ring-shaped manner and engaged with the engaging hole 15d which is formed in a circular shape and thus the impeller 12 and the rotor yoke 15 are further firmly fixed to each other.

Further, in this embodiment, the protruding amount in the axial direction of the abutting part 12g which is formed on the bottom part 12b of the impeller 12 is set to be larger than the protruding amount in the axial direction of the projecting parts 12f. Therefore, the stator part 3 is not abutted with the thermal welding parts 12h and thus damage of the thermal welding part 12h due to abutting with the stator part 3 is prevented. Therefore, displacement of the impeller 12 from the rotor yoke 15 can be prevented surely.

In this embodiment, the radial ribs 12e directing from the upper ends of the ribs 12d to the center of the bottom part 12b are radially formed on the bottom part 12b of the impeller 12 so as to protrude in the axial direction and the bottom part 15a of the rotor yoke 15 is abutted with the radial ribs 12e. Therefore, even when the bottom part 15a of the rotor yoke 15 is abutted with the bottom part 12b of the impeller 12 for positioning the rotor yoke 15 in the axial direction, a thickness of the bottom part 12b of the impeller 12 may be set arbitrarily. Therefore, wall thicknesses of respective portions of the impeller 12 formed of resin can be roughly equalized and thus shrinkage at the time of resin molding can be prevented.

In this embodiment, the ribs 12d are formed so as to correspond to the forming positions of the blades 12a and the blades 12a are fixed to the rotor yoke 15 in the state that the blades 12a are abutted with the outer peripheral face 15e of the large diameter cylindrical part 15c of the rotor yoke 15 through the ribs 12d. Therefore, for example, in comparison with a case that the blades 12a are formed on the outer peripheral face of impeller 12 at positions of the gap spaces 17 formed between the inner peripheral face 12c of the impeller 12 and the outer peripheral face 15e of the rotor yoke 15, the shape of the blades 12a of the impeller 12 is difficult to be deformed at the time of rotation of the rotor yoke 15 and thus a stable shape can be maintained.

Although the present invention has been shown and described with reference to a specific embodiment, various changes and modifications will be apparent to those skilled in the art from the teachings herein.

In the embodiment described above, a plurality of the ribs 12d protruding toward inner sides in the radial direction is formed on the inner peripheral face 12c of the impeller 12. However, the present invention is not limited to this embodiment. For example, a plurality of ribs protruding toward outer sides in the radial direction may be formed on the outer peripheral face 15e of the rotor yoke 15 instead of the ribs 12d or in addition to the ribs 12d. In this case, the rotor yoke 15 is press-fitted to the impeller 12 so that outer ends in the radial direction of a plurality of the ribs protruding to the outer sides in the radial direction are abutted with the inner peripheral face 12c of the impeller 12.

In the embodiment described above, eight ribs 12d are formed on the inner sides in the radial direction of the blades 12a with a substantially equal angular pitch. However, the present invention is not limited to this embodiment. For example, a plurality of the ribs 12d may be formed at positions shifted from the inner sides in the radial direction of the blades 12a or may be formed at a different angular pitch. Further, the number of the ribs 12d is not limited to eight and the number may be more than 9 or may be 2 through 7.

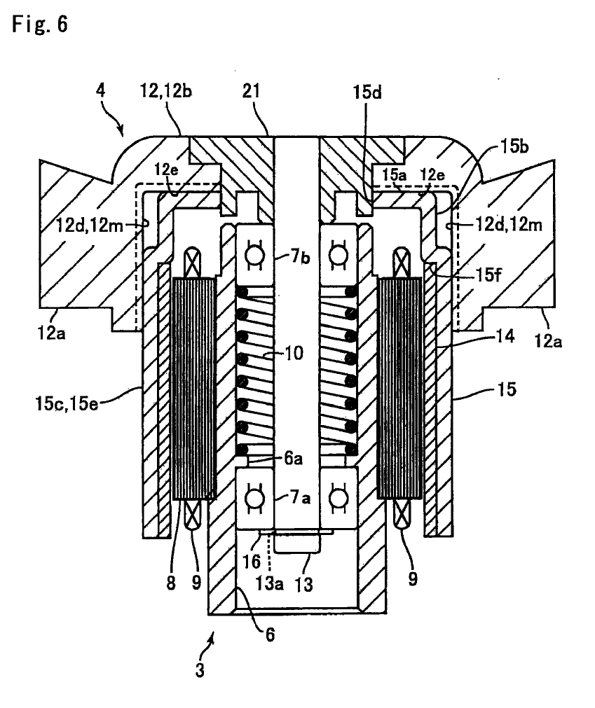

In the embodiment described above, the rotation shaft 13 is fixed to the impeller 12 by insert molding. However, for example, the rotation shaft 13 may be fixed to the impeller 12 by press-fitting. Further, instead of directly fixing the rotation shaft 13 to the impeller 12, for example, as shown in FIG. 6, the rotation shaft 13 may be fixed to a hub 21 which is disposed at a center of the bottom part 12b of the impeller 12 by press-fitting. In this embodiment, the hub 21 is one member for structuring the impeller 12 and, in this case, for example, the rotor yoke 15 is fixed to the hub 21 by caulking. Further, a part of the bottom part 12b of the impeller 12 is held in the axial direction by the bottom part 15a of the rotor yoke 15 and the hub 21. In FIG. 6, the same notational symbol is used in the same structure as the embodiment described above.

In the embodiment described above, the rotation shaft 13 is fixed to the impeller 12 and the rotation shaft 13 is rotated together with the impeller 12. However, the present invention is not limited to this embodiment. For example, a fixed shaft may be disposed in the stator part 4 and the impeller 12 is rotatably supported by the fixed shaft. In other words, the fan motor 1 described above is a shaft rotation type motor but the present invention may be applied to a shaft fixed type motor.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A fan motor comprising:
a rotor part which includes a drive magnet; and
a stator part which includes a drive coil and rotatably holds the rotor part;
wherein the rotor part comprises:
a rotor yoke to which the drive magnet is fixed on an inner peripheral side of the rotor yoke;
an impeller which is provided with a plurality of blades and which is disposed on an outer peripheral side of the rotor yoke; and
a plurality of ribs which are protruded from at least one of an inner peripheral face of the impeller and an outer peripheral face of the rotor yoke in a radial direction;
wherein the rotor yoke is press-fitted to the impeller so that end parts in the radial direction of the ribs are abutted with at least one of the inner peripheral face of the impeller and the outer peripheral face of the rotor yoke, and
gap spaces are formed between adjacent ribs of the plurality of the ribs and between the inner peripheral face of the impeller and the outer peripheral face of the rotor yoke.

2. The fan motor according to claim 1, wherein the ribs are formed on at least one of the inner peripheral face of the impeller and the outer peripheral face of the rotor yoke with a substantially equal angular pitch.

3. The fan motor according to claim 2, wherein the rib is formed on the inner peripheral face of the impeller so as to correspond to a forming position of the blade which is formed on the outer peripheral face of the impeller.

4. The fan motor according to claim 1, wherein
the impeller is formed of resin in a bottomed cylindrical shape,
the rotor yoke is formed in a bottomed cylindrical shape having a bottom part and a cylindrical part to which the drive magnet is fixed,
the rib is formed on the inner peripheral face of the impeller, and an inner side end in the radial direction of the rib and the outer peripheral face of the cylindrical part of the rotor yoke are abutted with each other, and
the bottom part of the rotor yoke is abutted with a bottom part of the impeller.

5. The fan motor according to claim 4, wherein a rotation shaft structuring the rotor part is fixed to the impeller by insert molding.

6. The fan motor according to claim 1, wherein
the impeller is formed of resin in a bottomed cylindrical shape,
the rotor yoke is formed in a bottomed cylindrical shape having a bottom part which is abutted with a bottom part of the impeller,
the bottom part of the impeller is formed with a projecting part which is protruded in an axial direction,
the bottom part of the rotor yoke is formed with an engaging hole with which the projecting part is engaged,
a tip end of the projecting part which is disposed on an edge of the engaging hole is protruded in the axial direction with respect to the engaging hole to be formed as a thermal welding part for fixing the impeller to the rotor yoke by thermal welding, and
the thermal welding part is thermally melted and welded to the edge of the engaging hole.

7. The fan motor according to claim 6, wherein
the bottom part of the impeller is formed with a plurality of the projecting parts in a ring-shaped manner, and
the engaging hole is formed in a circular shape at a center of the bottom part of the rotor yoke.

8. The fan motor according to claim 6, wherein
the bottom part of the impeller is formed with an abutting part for abutting with the stator part to restrict movement of the rotor part in the axial direction, and
the abutting part is protruded in same direction as the projecting part, and a protruding amount of the abutting part in the axial direction is larger than a protruding amount of the projecting part.

9. The fan motor according to claim 1, wherein
the impeller is formed of resin in a bottomed cylindrical shape,
the rotor yoke is formed in a bottomed cylindrical shape having a bottom part which is abutted with a bottom part of the impeller,
the rib is formed on the inner peripheral face of the impeller so as to reach at least to a boundary portion between the inner peripheral face of the impeller and the bottom part of the impeller,
the bottom part of the impeller is formed with radial ribs extending from end parts of the ribs toward a center of the bottom part of the impeller so as to protrude in the axial direction, and
the bottom part of the rotor yoke is abutted with the radial ribs.

10. The fan motor according to claim 9, wherein
an inner side end of the radial rib is formed with a projecting part protruding in the axial direction with respect to the radial rib,
the bottom part of the rotor yoke is formed with an engaging hole with which the projecting part is engaged,
a tip end of the projecting part which is disposed on an edge of the engaging hole is protruded in the axial direction with respect to the engaging hole to be formed as a thermal welding part for fixing the impeller to the rotor yoke by thermal welding, and
the thermal welding part is thermally melted and welded to the edge of the engaging hole.
